(19) United States
(12) Patent Application Publication
(10) Pub. No.: US 2009/0217193 A1
(43) Pub. Date: Aug. 27, 2009

(54) ELECTRONIC APPARATUS CAPABLE OF SETTING FUNCTIONS

(75) Inventor: Chigusa Tanaka, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/355,079

(22) Filed: Jan. 16, 2009

(30) Foreign Application Priority Data
Feb. 27, 2008 (JP) 2008-046264

(51) Int. Cl. G06F 3/048

(52) U.S. Cl. 715/781

(57) ABSTRACT

The present invention teaches and claims an interface device that facilitates use of and is adaptable to any electronic apparatus. The interface device includes but is not limited to a display unit for displaying a setting screen for setting at least one function; a setting unit for setting at least one function; an auxiliary display unit for displaying at least one associated auxiliary screen in association with at least one predetermined function under at least one predetermined condition.

### INCORPORATION BY REFERENCE

This application is based upon and claims the benefit of priority from the corresponding Japanese Patent Application No. 2008-046264, filed Feb. 27, 2008, the entire contents of which is incorporated herein by reference.

### FIELD OF THE INVENTION

The present invention relates to an electronic apparatus which is capable of setting functions through a touch panel or the like.

### BACKGROUND OF THE INVENTION

In recent years it is prevalent to use a touch panel for setting functions of electronic apparatuses for home and/or business. Typical examples of those electronic apparatuses include but are not limited to image forming apparatuses such as a copying machine and/or a multifunction peripheral. The image forming apparatuses have become essential business machines in business offices, etc., and also have become widespread in ordinary households. In addition, the functions of the electronic apparatuses thereof have become more diversified over time.

For example, a copying machine, in addition to having conventional functions such as image density control, enlargement and/or reduction of images and color printing, now includes additional functions such as duplex printing, combined printing in which a plurality of pages are reduced in size and printed on a single sheet, staple processing in which automatic stapling is performed after copying, etc.

Normally, the setting of these functions is accomplished by operating the conventional touch panel or the like. However, as the number of functions included increases and diversifies, for setting a multiple function there may be employed a configuration in which a plurality of setting screens are switched over and displayed. Such a configuration results in an increasing burden on a user. A person who is not familiar with a machine's operation needs to either read a cumbersome user's manual or ask for assistance each time using the machine.

To reduce the burden of operating electronic apparatuses as described above, the electronic apparatuses on the market now provide auxiliary screens (help screens) to assist operators of the apparatuses.

### SUMMARY OF THE INVENTION

An interface device facilitating the operation of an electronic apparatus according to one embodiment of the present invention comprises a setting unit for setting a function, a display unit for displaying a setting screen for setting the function, and an auxiliary display unit for displaying an associated auxiliary screen in association with a predetermined function under a predetermined condition. With this auxiliary display a user can access an auxiliary screen which aids and/or guides the user.

As is described above, according to one aspect of the present invention, the user can access a help screen in association with a function which the user currently wants to set. This feature is remarkably convenient at a time when the user is at a loss as to the operation of an electronic apparatus.

The above and other objects, features, and advantages of the present invention will be more apparent from the following detailed description of preferred embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is an overall structure diagram of a multifunction peripheral with an interface device according to an embodiment of the present invention;

FIG. 2 is a hardware structure diagram of the multifunction peripheral with an interface device according to an embodiment of the present invention;

FIG. 3 is a software structure diagram of the interface device of the multifunction peripheral according to an embodiment of the present invention;

FIGS. 4A, 4B, and 4C illustrate examples of setting screens provided by the interface device according to an embodiment of the present invention;

FIGS. 5A, 5B, and 5C illustrate examples of associated auxiliary screens provided by the interface device according to an embodiment of the present invention;

FIGS. 6A and 6B illustrate examples of display modes for the associated auxiliary screens provided by the interface device according to an embodiment of the present invention; and

FIGS. 7A, 7B, and 7C illustrate examples of associated auxiliary screens provided by the interface device according to another embodiment of the present invention.

### DETAILED DESCRIPTION OF THE PREFERRED EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents.

Hereinafter, with reference to the accompanying drawings, various embodiments of the present invention are described to help understand the present invention. In those embodiments, the present invention is embodied as an interface device of a multifunction peripheral, which is one form of electronic apparatuses.

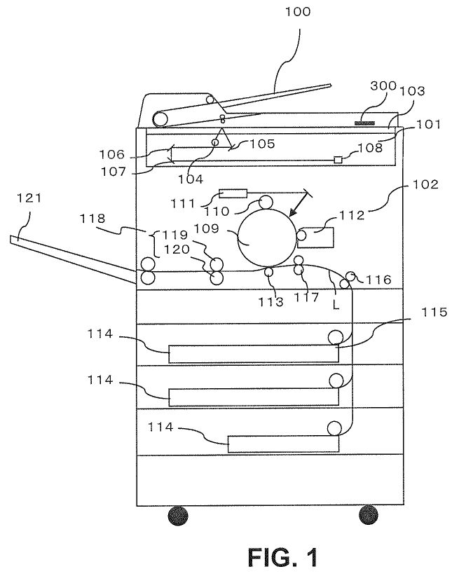

FIG. 1 is a schematic view illustrating an overall structure of a multifunction peripheral 100 with the interface device according to the present invention. When a user copies a document using the multifunction peripheral 100, the user first places the document on, for example, a document tray 103. The user then enters an instruction to copy by operating buttons on a touch panel 300 provided in the vicinity of the document tray 103 or hard keys (not shown). In response to the instruction, such units (driving units) as described below are operated, whereby copying is performed. In this embodiment, a touch panel 300 works as an interface device of the present invention. This is no limitation of the present invention, various embodiments may be applied.

In an image reading unit 101, light emitted from a light source 104 is reflected off the document which is placed on the document tray 103. The reflected light then is directed, by means of mirrors 105, 106, and 107, to an image pickup element 108 such as a charge coupled device (CCD). The image pickup element 108 subjects the received light to photoelectric conversion and then generates image data of the document. In this manner, the image data of the document is read out in the image reading unit 101.

A photosensitive drum 109 provided in an image forming unit 102 rotates in a predetermined direction at a fixed rate. Around the photosensitive drum 109, a charger 110, an exposure device 111, a developing device 112, and a transfer device 113 are arranged in this order from upstream of the rotational direction of the photosensitive drum 109. The charger 110 uniformly charges a surface of the photosensitive drum 109. The exposure device 111 emits light in accordance with the image data read out by the image reading unit 101 and forms an electrostatic latent image on the photosensitive drum 109. The developing device 112 attaches toner on the electrostatic latent image formed by the exposure device 111, thereby forming a toner image on the photosensitive drum 109. The transfer device 113 transfers the toner image formed on the photosensitive drum 109 onto a sheet. In this manner, by rotating the photosensitive drum 109, a series of processes described above is performed in the image forming unit 102.

When printing is performed in the image forming unit 102, one sheet of paper is drawn toward a conveying path L from any one of sheet feed cassettes 114 by means of a pickup roller 115 provided thereto. Sheets of different sizes are accommodated in the respective sheet feed cassettes 114. Paper of a selected size for the user's intended use is fed. The paper drawn to the conveying path L is conveyed by means of convey rollers 116 and registration rollers 117, between the photosensitive drum 109 and the transfer device 113.

At a fixing device 118, when the paper passes between a heating roller 119 and a pressure roller 120, a visualized image is fixed onto the paper. In order to perform the fixing appropriately, the amount of heat provided from the heating roller 119 is optimally set depending on the size of the paper. The image forming unit 102 discharges the paper, which has passed through the fixing device 118, to a discharge tray 121.

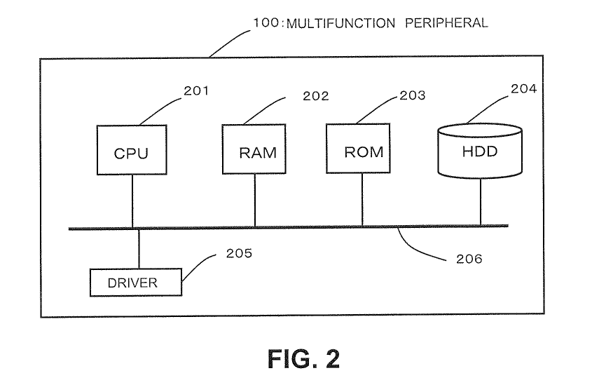

FIG. 2 is a schematic diagram relating to various controls of the multifunction peripheral 100 with the interface device according to the present invention.

The multifunction peripheral 100 generally comprises a central processing unit (CPU) 201, a random access memory (RAM) 202, a read only memory (ROM) 203, a hard disk drive (HDD) 204 and a driver 205 which handles the above-mentioned driving units during printing. These units are connected to one another via an internal bus 206.

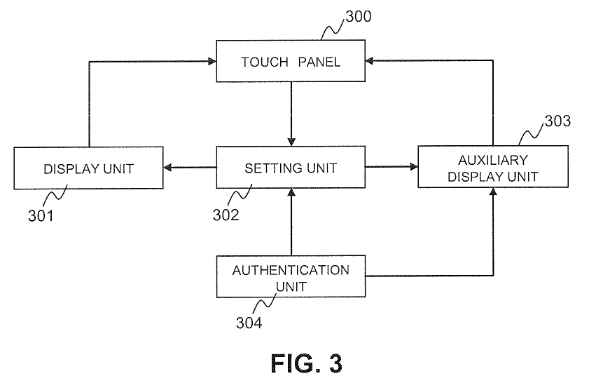

The CPU 201 uses, for example, the RAM 202 as a work area and executes programs stored in the ROM 203, the HDD 204, or the like. By exchanging data and commands with the driver 205 based on execution results, the CPU 201 controls operations of the respective driving units illustrated in FIG. 1. In addition, by executing the programs the CPU 201 also causes units (illustrated in FIG. 3) described below other than the driving units to operate. An associated auxiliary screen program according to an embodiment of the present invention is stored in the ROM 203 or the HDD 204.

FIG. 3 is a software schematic diagram of the interface device of the multifunction peripheral 100 according to an embodiment of the present invention.

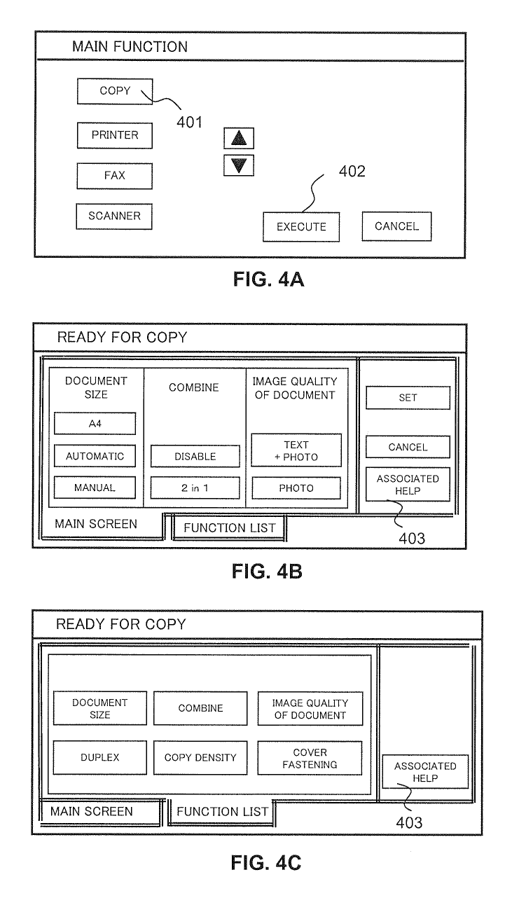

FIGS. 4A, 4B, and 4C illustrate the setting screen which is provided by the interface device according to an embodiment of the present invention.

First, before a user starts copying, a display unit 301 displays a main function screen as illustrated in FIG. 4A on the touch panel 300. In the example, FIG. 4A shows that the multifunction peripheral 100 is installed with the following four main functions: a copy function, a printer function, a facsimile function and a scanner function. In order to perform copying, the user first depresses a copy button 401 and then depresses an execution button 402.

Subsequently, the display unit 301 retrieves information regarding copy settings from a setting unit 302 and then displays on the touch panel 300 such a setting screen for the copy function as illustrated in FIG. 4B. In the example of FIG. 4B, three functions “document size”, “combined printing” and “image quality of document” are displayed on a main screen. For example, the “document size”, the “combined printing” and the “image quality of document” may be set to “A4”, “disable”, and “text+photo”, respectively. In this embodiment, the setting screen includes the main screen illustrated in FIG. 4B and a function list screen illustrated in FIG. 4C, which can be switched between each other.

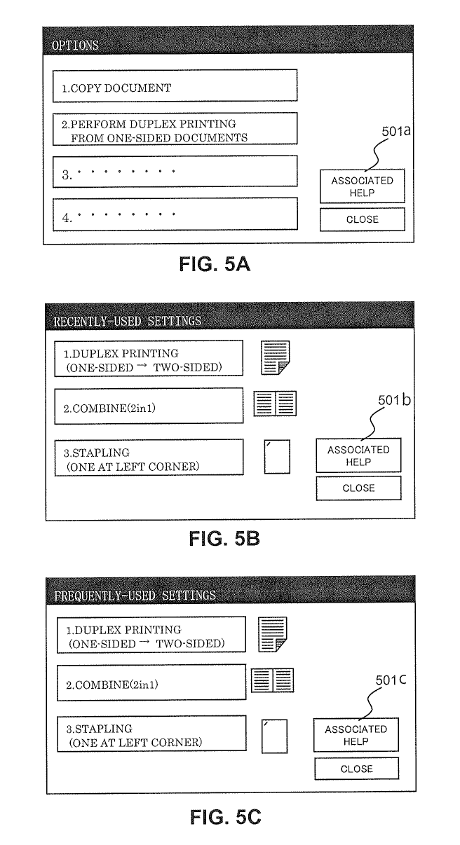

FIGS. 5A, 5B, and 5C illustrate the associated auxiliary screen which is provided by the interface device according to an embodiment of the present invention.

In a case where the copy function is set and the copy function screen is displayed as in the above-mentioned example, illustrated in FIG. 5A, an auxiliary display unit 303 retrieves information regarding the copy function to display the associated auxiliary screen. This associated auxiliary screen is associated with the currently-designated function, i.e., the copy function, in this example. In the example of FIG. 5A, the options with respect to the copy function are displayed in a list in an itemized manner such as copying a document, duplex printing from one-sided documents, etc. When the user selects, for example, the “copy document” option in the associated auxiliary screen, guidance information regarding the procedure to copy the document is displayed.

To give another example, as illustrated in FIG. 5B, the auxiliary display unit 303 displays on the touch panel 300 an associated auxiliary screen based on a history of the copy function settings.

For this configuration to be realized, the interface device of the multifunction peripheral 100 also includes but is not limited to a history management unit which manages the history of the copy function settings inputted through the setting unit 302. In the example of FIG. 5B, the displayed list of the recently-used settings is a predetermined number in the order of the most recent setting items with respect to the predetermined function. Moreover, the list as shown in FIG. 5B includes duplex printing (producing two-sided printing from one-sided documents), combine (printing two pages onto one sheet), stapling, etc.

Further, to the right of each section of the list, minified images (icon images) which illustrate finished appearances of the settings are displayed for the user's convenience. As described above, the associated auxiliary screen may display both the list and the icon images, or may display only the list or the icon images.

An authentication unit 304 may be provided to authenticate and verify the identity of a user, for example, by using an ID card or the like. The history management unit may manage the history of settings used by each user, and the auxiliary display unit 303 may display the associated auxiliary screen based on the history of each user.

To give yet another example, as illustrated in FIG. 5C, the auxiliary display unit 303 displays on the touch panel 300 the associated auxiliary screen based on frequencies of the copy function settings.

For this configuration to be realized, the interface device of the multifunction peripheral 100 is provided with the history management unit which manages the setting history of the copy function preformed by the setting unit 302. The auxiliary display unit 303 obtains a frequency of use for each function from the history management unit which is then displayed on the associated auxiliary screen. In the example of FIG. 5C, settings are displayed in a predetermined number in the order of the most frequently-used setting items with respect to a predetermined function. The list in the example of FIG. 5C displays duplex printing (producing two-sided printing from one-sided documents), combine (printing two pages onto one sheet), stapling, etc. Furthermore, as in the case described above, an authentication unit 304 may be provided and the auxiliary display unit 303 may manage the setting frequencies for each user and display the associated auxiliary screen based on the frequencies of each user.

A flow for displaying the associated auxiliary screen will now be described in detail below.

When a user depresses an associated help button 403 through operation of the touch panel 303, it is assumed that the user is requesting the auxiliary screen. Accordingly, the auxiliary display unit 303 reads out from, for example, the HDD 204 auxiliary screen information associated with the copy function which is currently designated, and displays the auxiliary screen on the touch panel 300.

Further, the associated auxiliary screen is also displayed when the user is at a loss as to operation of the setting screen. The interface device according to the present invention assesses whether or not the user is at a loss based on predetermined conditions in the following manner.

First, while the setting screen is displayed, if the user does not perform a function setting within a predetermined period of time (e.g., one minute) (predetermined condition 1), for example, by not touching the touch panel, the auxiliary display unit 303 reads it as that the user is at a loss as to the operation of the setting screen. The auxiliary display unit 303 then displays the associated auxiliary screen on the touch panel 300.

Next, similarly, while the setting screen is displayed, the number of times the user can cancel the setting of a function is predetermined. If the number of the canceling is greater than a predetermined number of times (e.g., three times) (predetermined condition 2), the auxiliary display unit 303 reads that the user is at a loss as to the operation of the setting screen. In the same manner as described above, the auxiliary display unit 303 then displays the associated auxiliary screen on the touch panel 300.

Further, the same applies to the following scenario. While the setting screen is displayed, a user repeatedly operates the display unit for a predetermined function, for example, by entering and exiting the setting screen repeatedly greater than a predetermined number of times (e.g., five times) (predetermined condition 3). The auxiliary display unit 303 reads that the user is at a loss as to the operation of the setting screen, and then displays the associated auxiliary screen on the touch panel 300.

Note that each of the above-mentioned predetermined conditions 1, 2, and 3 may be employed individually and/or in combination with two or more conditions that may also be employed.

As described above, according to an embodiment of the present invention, a help screen associated with a function which the user is currently attempting to set can be displayed at an appropriate time, which is remarkably convenient in terms of operating an electronic apparatus.

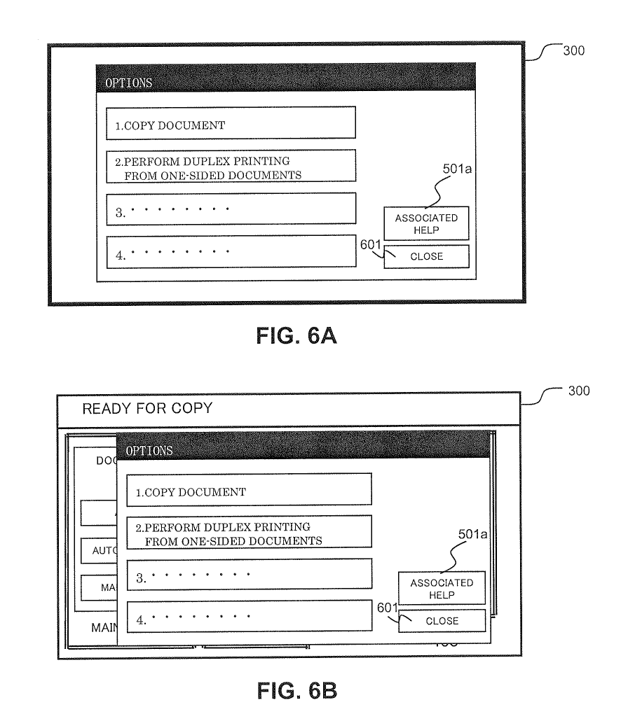

Note that the associated auxiliary screens illustrated in FIGS. 5A, 5B, and 5C may be displayed alone on the touch panel 300 as illustrated in FIG. 6A. Alternatively, the auxiliary screens may be displayed in a manner that overlaps the setting screen of FIG. 4B as illustrated in FIG. 6B. When the user does not need the associated auxiliary screen, the user can close the associated auxiliary screen by depressing a close button 601.

In the above-mentioned embodiment, three examples illustrating the associated auxiliary screens in FIGS. 5A, 5B, and 5C have been used for description, but those have been used only by way of example to explain the spirit of the present invention, and they are by no way intended to limit the scope of the present invention. One skilled in the art can employ variations of the associated auxiliary screens without departing from the present invention.

Further, the above-mentioned embodiment describes one situation where a single associated auxiliary screen is displayed. However, by providing associated help buttons 501a, 501b, and 501c to the associated auxiliary screens of FIG. 5A, FIG. 5B, and FIG. 5C, respectively, other embodiments exist where a plurality of associated auxiliary screens may be accessed by being switched between and displayed.

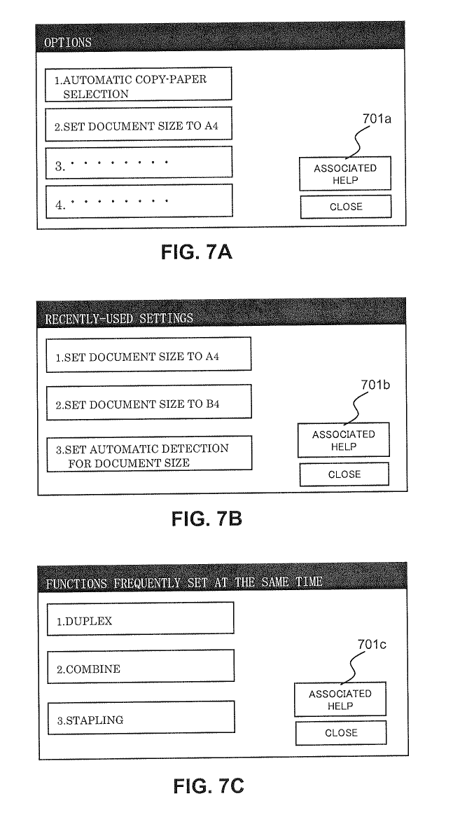

Further, in the above-mentioned embodiment, while the associated auxiliary screen associated with the copy function is considered to be one of the main functions, however, other embodiments of the present invention can also display associated auxiliary screens for any other functions, i.e., lower-level functions. For example, functions include but are not limited to sub-functions of the copy function including “document size”, “image density control”, “enlargement/reduction”, “combined printing”, “image quality of document”, etc. Such an embodiment is described with reference to FIG. 7.

For example, while the setting screen for a function of the “document size” is displayed, and when the user does not select a setting within a predetermined period of time, options such as “set automatic detection for document size” and “set document size to A4” may be displayed in an associated auxiliary screen associated with the document-size setting function (FIG. 7A). Further, as illustrated in FIG. 7B, from among the options for the document-size setting function, settings which have been used recently may be displayed in a list. Further, as illustrated in FIG. 7C, functions which are frequently set along with the document-size setting function may be displayed in a list. Furthermore, in this embodiment, a plurality of associated auxiliary screens may also be switched over and displayed by depressing associated help buttons 701a, 701b, and 701c of the respective associated auxiliary screens.

In the above-mentioned embodiment, a description has been made by applying the predetermined condition 1 as a standard reference as to whether or not the user is at a loss. However, the predetermined condition 2 or 3 may be applied individually and/or in combinations with each other.

The predetermined condition 2 may be so set that, for example, when the number of times the user has canceled the size setting is greater than a predetermined number of times, the associated auxiliary screen is displayed. Moreover, the predetermined condition 3 may be so set that, for example, when a user repeatedly operates the display unit to display the document-size setting screen greater than a predetermined number of times, the associated auxiliary screen is displayed. Specifically, the following scenario corresponds to this embodiment. After switching from the setting function list screen illustrated in FIG. 4C to the document-size setting screen through the user's operation, the screen is returned to the setting function list screen illustrated in FIG. 4C using a cancel button (not shown) or the like. The screen is switched to the document-size setting screen again through the user's operation.

In the above-mentioned description, the multifunction peripheral has been explained by way of an example which provides the interface device. However, the present invention is applicable to any electronic apparatus with interface device for which function settings or the like are performed through operation of a touch panel or the like, such as an automated teller machine (ATM), an automatic airline ticket machine, and a car navigation system.

Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. An interface device facilitating the operation of an electronic apparatus, comprising:
a display unit for displaying a setting screen for setting at least one function;
a setting unit for setting at least one function;
an auxiliary display unit for displaying an associated auxiliary screen associated with at least one predetermined function under at least one predetermined condition.

2. The interface device according to claim 1, wherein the predetermined condition is activated when a user provides an instruction.

3. The interface device according to claim 1, wherein the predetermined condition is activated when a user fails to perform a function setting within a predetermined period of time.

4. The interface device according to claim 1, wherein the predetermined condition is activated when the number of canceling the setting of the function is greater than a predetermined number of times.

5. The interface device according to claim 1, wherein the predetermined condition is activated when the number of operating the display unit for displaying the setting screen is greater than a predetermined number of times.

6. The interface device according to claim 1, wherein the associated auxiliary screen displays at least one option with respect to the predetermined function in a list.

7. The interface device according to claim 1, further comprising a history management unit for managing a record set by the setting unit,
wherein the associated auxiliary screen displays a predetermined number of the most recent settings with respect to a list of the predetermined function.

8. The interface device according to claim 1, further comprising a history management unit for managing a record set by the setting unit,
wherein the associated auxiliary screen displays a predetermined number of the most frequent settings with respect to a list of the predetermined function.

9. The interface device according to claim 7, further comprising an authentication unit for authenticating a user,
wherein the history management unit manages the record of settings used by each user.

10. The interface device according to claim 8, further comprising an authentication unit for authenticating a user,
wherein the history management unit manages the record of settings used by each user.

11. The interface device according to claim 1, wherein the auxiliary display unit is capable of switching between a plurality of associated auxiliary screens.

12. An image forming apparatus, comprising:
a display unit for displaying a setting screen for setting at least one function;
a setting unit for setting at least one function;
an auxiliary display unit for displaying an associated auxiliary screen associated with at least one predetermined function under at least one predetermined condition;
an image forming unit for performing to print an image data onto a sheet.
